(19) United States
(12) Patent Application Publication
(10) Pub. No.: US 2020/0308466 A1
(43) Pub. Date: Oct. 1, 2020

(54) GRAPHITE SHEET AND THE SHEET MANUFACTURING METHOD

(71) Applicant: UNICOH SPECIALTY CHEMICALS CO., LTD., Pohang-si (KR)

(72) Inventors: Bang Cha Rang SONG, Pohang-si (KR); Lyong Jin Lee, Seoul (KR); Yoonyoung Ko, Daejeon (KR); Myeong Rang Chae, Busan (KR)

(21) Appl. No.: 16/832,123

(22) Filed: Mar. 27, 2020

(30) Foreign Application Priority Data
Mar. 29, 2019 (KR) 10-2019-0036750

(51) Int. Cl. C09K 5/14; C01B 32/205; C01B 32/21

(52) U.S. Cl. CPC C09K 5/14; C01B 32/205; C01B 2204/24; C01B 2202/24; C01P 2006/11; C01B 32/21

(57) ABSTRACT

The present invention is related to a graphite sheet and a method for manufacturing the same. A graphite sheet comprising an expanded graphite and a carbon nanotube, the carbon nanotube has a tap density of 0.001 to 0.01 g/cc, and a content of the carbon nanotube is 1 to 50% by weight, is provided.

### CROSS-REFERENCE TO RELATED APPLICATION

This application claims priority to and the benefit of Korean Patent Application No. 10-2019-0036750 filed in the Korean Intellectual Property Office on Mar. 29, 2019, and Korean Patent Application No. filed in the Korean Intellectual Property Office on, the entire contents of which are incorporated herein by reference.

### BACKGROUND OF THE INVENTION

### (a) Field of the Invention

It is related to a graphite sheet and its manufacturing method.

### (b) Description of the Related Art

A heat diffusion sheet is a product that facilitates dissipation of heat from a heat source surface such as an electronic product into a cooler environment. That is, the heat-diffusion sheet is mainly used to directly or indirectly contact a heat source to diffuse heat in a sheet direction or a thickness direction of the sheet to effectively dissipate heat generated from the product. In electronic products such as mobile phones, digital (video) cameras, laptops, PDAs, PMPs, and imaging equipment such as plasma display panels (PDPs), liquid crystal displays (LCDs), light emission displays (LEDs), organic light emission displays (OLEDs), FEDs (Ferroelectric Emission Display), an isotropic metal material having excellent thermal conductivity such as copper and aluminum and an anisotropic material in the form of a sheet made by expanding graphite are mainly used. However, metal materials, such as copper and aluminum, have a high density and have limitations in reducing the weight of the product. In addition, because they are isotropic, they cannot obtain an efficient heat diffusion effect and further have a high manufacturing cost. On the other hand, anisotropic graphite sheet has been spotlighted as a useful heat diffusion material in that it can compensate for the disadvantages of metal materials. As a technology using graphite as a heat diffusion material, U.S. Pat. Nos. 5,831,374 and 6,482,520 are exemplified. In the illustrated prior patents, an anisotropic graphite film and a sheet of graphite particles are used as heat diffusion materials, respectively. The anisotropic graphite sheet known in the illustrated U.S. Pat. No. 6,482,520 does not effectively absorb heat in the thickness direction of the sheet because of its high anisotropy. Because it predominantly diffuses heat only in the surface direction of the sheet, it does not absorb and diffuse heat caused in the center effectively. If the heat generated in the central portion is not effectively absorbed and diffused, a thermal imbalance (hot spot) is caused in the entire display panel, which consequently limits the efficiency and lifetime of the device. This disadvantage can be solved by controlling the anisotropy. A technique for efficiently absorbing and diffusing locally generated heat through anisotropic regulation is disclosed in U.S. Pat. No. 3,492,197. In the illustrated prior patent, anisotropy is controlled by compressing the expanded graphite sheet by applying different pressures in different axial directions. However, this method is a technique for controlling the degree of anisotropy of expanded graphite by a processing method. In manufacturing a large-area graphite sheet, it is difficult to design a mold to apply pressure in different axial directions, and a large device must be provided. Accordingly, it has the disadvantage of high cost and low productivity.

### SUMMARY OF THE INVENTION

Accordingly, the present invention is to provide a method capable of producing a graphite sheet having excellent thermal conductivity in a sheet direction (longitudinal direction) as well as in a thickness direction with a simple process and low cost.

An exemplary embodiment of the present invention provides a graphite sheet comprising: an expanded graphite and a carbon nanotube, the carbon nanotube has a tap density of 0.001 to 0.01 g/cc, a content of the carbon nanotube is 1 to 50% by weight.

A content of the carbon nano tube may be 10 to 30% by weight.

An aspect ratio (a-axis/c-axis) of the carbon nanotube may be 0.1 to 1.

The graphite sheet may have a thermal conductivity in the thickness direction of 0.5 to 1 compared to a thermal conductivity in the longitudinal direction.

Another exemplary embodiment of the present invention provides a method of preparing a graphite sheet comprising: preparing a natural graphite; obtaining an expanded graphite by expanding the natural graphite; obtaining a composition by mixing the expanded graphite and a carbon nano tube; and preparing the graphite sheet by compression molding the composition; wherein, a content of the carbon nanotube in the composition is 1 to 50% by weight.

A content of the carbon nano tube in the composition may be 10 to 30% by weight.

The step of obtaining expanded graphite by expanding the natural graphite is performed by a method of supplying energy using heat and/or electromagnetic radiation.

A graphite sheet having excellent thermal conductivity can be obtained not only in the surface direction (longitudinal direction) of the sheet but also in the thickness direction.

### DETAILED DESCRIPTION OF THE EMBODIMENTS

Hereinafter, embodiments of the present invention will be described in detail. However, this is presented as an example, and the present invention is not limited thereby, and the present invention is only defined by the scope of claims to be described later.

Graphite is composed of graphene formed by sp2 bonds between carbon atoms, and that is composed of a vertical stack of graphene.

Graphene composed of sp2 bonds between carbon atoms has a two-dimensional plate-like structure, and electrons and phonons are rapidly conducted in a two-dimensional structure due to the unlocalized π-bonding of graphene. Accordingly, it has high thermal and electrical conductivity.

The manufacturing process of the existing graphite sheet has the following sequence.

1. Expansion process: A process of manufacturing expanded graphite by supplying energy such as heat and micro-wave to graphite raw materials (natural graphite, expandable graphite)

2. Loading process: A process of loading a certain amount of expanded graphite entering the continuous rolling process onto a conveyor

3. Continuous rolling process: A process of manufacturing a graphite sheet in the form of film by rolling a certain amount of expanded graphite through two or more rolls.

Graphite stacked by a van der Waals bond between graphenes has a relatively low electrical and thermal conductivity in a direction perpendicular to the stacking of graphenes compared to the horizontal direction. This is caused by the vertical bond between graphenes by the van der Waals bond.

Thus, the graphite sheet has a problem of low thermal and electrical conductivity in the thickness direction (c-axis direction) as described above.

Accordingly, in one embodiment of the present invention, it is intended to provide a graphite sheet using a carbon nano tube.

Carbon nanotubes have a sp2 bond between carbon atoms, but do not have a 2D plate-like structure such as graphene or graphite, and the ends and ends of graphene are combined with each other to form a tube.

In addition, the carbon nanotube may be selected to have vertical and horizontal conductivity similar to horizontal conductivity of graphene.

The graphite sheet to which it is applied is capable of improving the vertical electrical and thermal conductivity by conducting electrons and electrons that are quickly conducted between graphene planes and vertically conducting carbon nanotubes in a 3D structure.

In a process aspect, various additives such as metals and minerals may be used as additives in the prior graphite sheet manufacturing process.

However, due to the low specific gravity (tap density: 0.001-0.01 g/cc) among the properties of expanded graphite, the process of adding other additives is accompanied not only by the additive injection process but also by the mixing process for uniform mixing of the additives. In addition, the mixing of additives requires a high technical level.

Accordingly, the carbon nanotube as an additive presented in one embodiment of the present invention can be controlled to have a specific gravity (tap density: 0.001 g/cc to 0.01 g/cc) similar to that of expanded graphite.

From this, a separate uniform mixing process is not accompanied, and a desired sheet can be manufactured only through an additive injection process among prior manufacturing processes.

More specifically, the carbon nanotube may have a tap density of 0.001 to 0.01 g/cc. This is a range for specific gravity similar to that of the graphite raw material as described above, and if this range is satisfied, the entire process can be simplified.

A content of the carbon nanotube may be 1 to 50% by weight. More specifically, it may be 10 to 30% by weight. This is a range that can complement the properties of the a-axis and c-axis within a range that does not impair the function as a graphite sheet.

The aspect ratio of the carbon nanotube (a-axis/c-axis) may be 0.1 to 1. If the aspect ratio is too large, it may be a problem with mixing and arrangement with graphite, and if it is too small, the effect of improving the properties in the thickness direction may be insignificant.

The graphite sheet may have a thermal conductivity in the thickness direction of 0.5 to 1 compared to a thermal conductivity in the longitudinal direction. Preferably, the characteristics of the length direction and the thickness direction can be improved to a similar level.

The present invention is not limited to the embodiments, but may be manufactured in various different forms, and those skilled in the art to which the present invention pertains have other specific forms without changing the technical spirit or essential features of the present invention. It will be understood that can be carried out. Therefore, it should be understood that the embodiments described above are illustrative in all respects and not restrictive.

What is claimed is:

1. A graphite sheet comprising:
an expanded graphite and a carbon nanotube,
the carbon nanotube has a tap density of 0.001 to 0.01 g/cc,
a content of the carbon nanotube is 1 to 50% by weight.

2. The graphite sheet of claim 1, wherein:
a content of the carbon nanotube is 10 to 30% by weight.

3. The graphite sheet of claim 1, wherein:
an aspect ratio of a carbon nanotube (a-axis/c-axis) is from 0.1 to 1.

4. The graphite sheet of claim 1, wherein:
the graphite sheet has a thermal conductivity in the thickness direction of 0.5 to 1 compared to a thermal conductivity in the longitudinal direction.

5. A method of preparing a graphite sheet comprising:
preparing a natural graphite;
obtaining an expanded graphite by expanding the natural graphite;
obtaining a composition by mixing the expanded graphite and a carbon nano tube; and
preparing the graphite sheet by compression molding the composition;
wherein, a content of the carbon nanotube in the composition is 1 to 50% by weight.

6. The method of claim 5, wherein:
the carbon nanotube in the composition is 10 to 30% by weight.

7. The method of claim 5, wherein:
the step of obtaining an expanded graphite by expanding the natural graphite is performed by a method of supplying energy using heat and/or electromagnetic radiation.
